(19) United States
(12) Patent Application Publication
(10) Pub. No.: US 2025/0340017 A1
(43) Pub. Date: Nov. 6, 2025

(54) SYSTEM AND METHOD FOR REMOVAL OF RESIN FROM 3D PRINTED OBJECTS

(71) Applicant: PostProcess Technologies, Inc., Buffalo, NY (US)

(72) Inventors: Craig Ostrum, Amherst, NY (US); Jason Zilbauer, Buffalo, NY (US); Daniel Hutchinson, Orchard Park, NY (US)

(73) Assignee: PostProcess Technologies, Inc., Buffalo, NY (US)

(21) Appl. No.: 18/879,974

(22) PCT Filed: Jun. 21, 2023
(86) PCT No.: PCT/US2023/025872

§ 371 Date: Dec. 30, 2024

Related U.S. Application Data
(60) Provisional application No. 63/359,315, filed on Jul. 8, 2022.

(51) Int. Cl. B29C 64/30; B08B 3/10; B08B 13/00; B33Y 40/20

(52) U.S. Cl. CPC B29C 64/30; B08B 3/10; B08B 13/00; B33Y 40/20

(57) ABSTRACT

A system and method are disclosed for removing resin from 3D printed objects. The system includes a housing in which is located a fixture adapted for attaching on a bottom side thereof a build tray, which is a component of a 3D printer upon which 3D printed objects are manufactured and which is removable from the 3D printer. The system also includes a lift mechanism located in the housing and connected to the fixture. The lift mechanism moves the fixture from an upper position to a lower position to immerse the build tray with the 3D printed parts in a container of a liquid formulation that removes resin from the 3D printed objects. The system may also provide for rinsing and curing the 3D printed objects after the unwanted resin has been removed.

### CROSS-REFERENCE TO RELATED APPLICATION

This application claims the benefit of the filing date under 35 U.S.C. § 119(e) of U.S. Provisional Application Ser. No. 63/359,315 filed Jul. 8, 2022 which is hereby incorporated by reference in its entirety.

### FIELD OF DISCLOSURE

The present disclosure pertains generally to a system and method for removing resin from objects formed by 3D printing processes.

### BACKGROUND OF THE DISCLOSURE

3D printing processes (also referred to as additive manufacturing processes), such as stereolithography (SLA), provide significant advantages for many applications. 3D printing processes enable the production of objects having complex geometries that would be difficult to make using traditional manufacturing techniques. Also, 3D printing processes enable the efficient production of low volumes of objects. However, some 3D printing processes produce objects that require removal of unwanted resin. After the printing portion of the process is completed, the unwanted resin must be removed before the 3D printed object can be used for its intended purpose.

Various approaches exist for removing resin from 3D printing objects. PostProcess Technologies, Inc. of Buffalo, NY has developed solutions for finishing 3D printed objects. These solutions include software-controlled machines and specially designed chemical formulations.

A PostProcess® solution for removing resin from 3D printed objects is described in U.S. Pat. No. 10,737,440, the disclosure of which is incorporated herein by reference. The solutions described in U.S. Pat. No. 10,737,440 as well as other systems from PostProcess Technologies, Inc., provide improved ways for finishing objects made by 3D printing. There exists room for further improvements.

### SUMMARY OF THE INVENTION

The disclosed invention includes a system and method for removing resin from 3D printed objects. The system includes a housing in which is located a fixture adapted for attaching on a bottom side thereof a build tray, which is a component of a 3D printer in which 3D printed objects are manufactured and which is removable from the 3D printer. The system also includes a lift mechanism located in the housing and connected to the fixture. The lift mechanism moves the fixture from an upper position to a lower position where the build tray with the 3D printed parts thereon is immersed in a container of a liquid formulation that removes the resin. The system may also provide for rinsing and curing the 3D printed objects after the unwanted resin has been removed.

### BRIEF DESCRIPTION OF THE DRAWINGS

For a fuller understanding of the nature and objects of the invention, reference should be made to the accompanying drawings and the subsequent description.

FIG. 1 is a perspective view of an SLA 3D printer.

FIG. 2 is perspective view of a build tray used in the 3D printer shown in FIG. 1 with 3D printed objects located thereupon.

FIG. 3 is perspective view of another build tray used in the 3D printer shown in FIG. 1 with 3D printed objects located thereupon.

FIG. 4 is a perspective view of first embodiment of a system for removing resin from 3D printed objects.

FIG. 5 is a perspective view of the frame of the embodiment of the system shown in FIG. 4.

FIG. 6 is a cross sectional perspective view of the system shown in FIG. 4.

FIG. 7 is a perspective view of the build tray and the build tray mounting fixture shown in FIG. 6.

FIG. 8 is a cutaway side view of the system shown in FIGS. 4 and 6.

FIG. 9 is a perspective view a multi-build tray mounting fixture with build trays and 3D printed objects mounted thereupon.

FIG. 10 is a perspective view of the system shown in FIG. 4 with the multi-build tray mounting fixture mounted therein.

FIG. 11 is a perspective view of the system shown in FIG. 10 with a pedestal accessory.

### DETAILED DESCRIPTION OF THE INVENTION

Like drawing numbers on different drawing views identify identical, or functionally similar, structural elements of the invention.

Furthermore, it is understood that this invention is not limited to the particular methodology, materials, or modifications described and, as such, the invention may vary from that which is disclosed herein. It is also understood that the terminology used herein is for the purpose of describing particular aspects, and this invention is not limited to the disclosed aspects.

Unless defined otherwise, all technical and scientific terms used herein have the same meaning as commonly understood to one of ordinary skill in the art to which this invention pertains. It should be understood that methods, devices or materials similar or equivalent to those described herein can be used in the practice or testing of the method and system.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

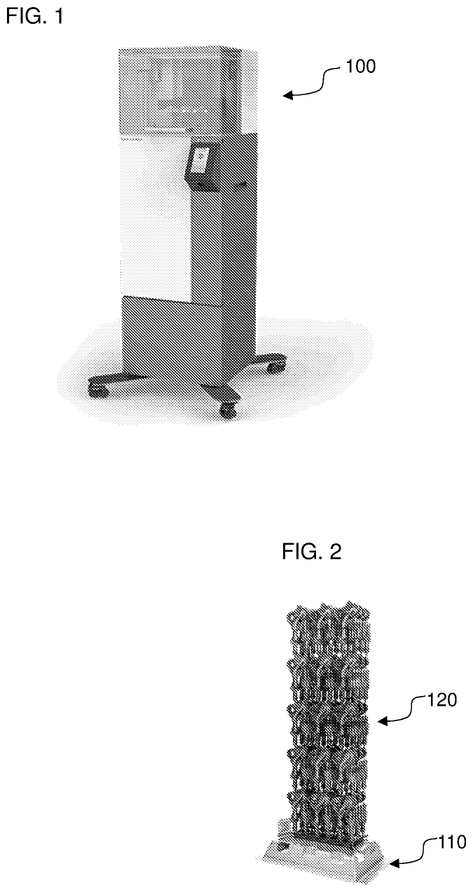

FIG. 1 shows a perspective view of a 3D printer 100. The 3D printer 100 uses stereolithography (SLA) for manufacturing 3D printed objects. The 3D printer 100 includes a build tray on which is a vat containing a layer of a photopolymer resin. A laser focuses an ultraviolet light beam in a computer-controlled pattern across the surface of the photopolymer resin causing the photopolymer resin under the beam to solidify. The build tray is lowered and another layer of photopolymer resin is spread across the surface. Then, the laser is focused in another pattern across the new layer causing the resin under the beam to harden and form another layer of the object. The process is repeated to form an entire 3D object. Once the entire 3D object is printed, the build tray is removed from the 3D printer. The build tray includes the solid 3D printed object on it, i.e., the solidified resin. The size of an object that can be printed is limited by the dimensions of the build tray and the vertical height in the 3D printer through which the build tray is lowered. Depending on the sizes of the objects, multiple objects can be printed in the same batch (or “build”) at the same time. Once the objects are printed, it is necessary to remove the unsolidified resin from the objects.

FIG. 2 shows a build tray 110. The build tray 110 is a component of a 3D printer, like the 3D printer 100 in FIG. 1. The build tray 110 in FIG. 2 is shown removed from a 3D printer, Located on the build tray 110 are 3D printed objects 120. Although much of the unsolidified resin drains off when the build tray 110 is removed from the 3D printer, some unsolidified resin remains on the surfaces of the 3D printed objects 120 on the build tray 110. The build tray 110 in FIG. 2 is shown after the 3D printed objects 120 had been built on the build tray 110 in the 3D printer 100 but before all the unsolidified resin has been removed from the 3D printed objects 120. At this stage, the 3D printed objects 120 have unwanted, unsolidified resin on surfaces thereof and are attached to the build tray 110. The 3D printed objects 120 in FIG. 2 are shown at the stage at which the unsolidified resin needs to be removed.

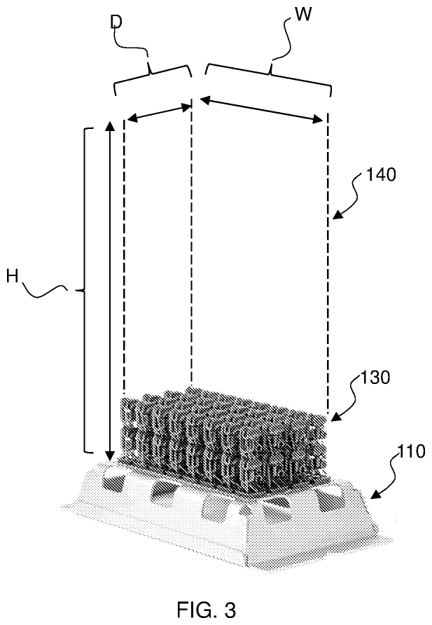

FIG. 3 shows the build tray 110. The build tray in FIG. 3 is the same build tray 110 as shown in FIG. 2. However, in FIG. 3, the build tray 110 is shown with different 3D printed objects 130 located thereupon. The 3D printed objects 130 shown in FIG. 3 were printed in the same 3D printer 100 as the 3D printed objects 120 shown in FIG. 2, but at a different time in a different build. As illustrated in FIGS. 2 and 3, the size, type, number, and dimensions of 3D printed objects produced in a single build by an SLA 3D printer can vary.

FIG. 3 shows a build envelope 140. The build envelope 140 is the volume of space above the build tray 110 in which a given 3D printer can build 3D printed objects, i.e., it defines the maximum size of an object, or set of objects, that can be 3D printed in single build operation. The build envelope 140 is defined by the dimensions of the build tray 110 and the vertical distance in the 3D printer through which the build tray 110 can be moved so that additional layers of photopolymer resin can be applied. In FIG. 3, the build envelope 140 is shown as defined by the dimensions, D, W, and H. As shown in FIG. 3, when a 3D printer prints 3D objects, the 3D objects do not need to occupy the entire build envelope 140. A 3D printer can print a batch of 3D objects that occupy only a portion of the entire build envelope 140. Different models of 3D printers that use SLA technology can have different sizes of build envelopes 140.

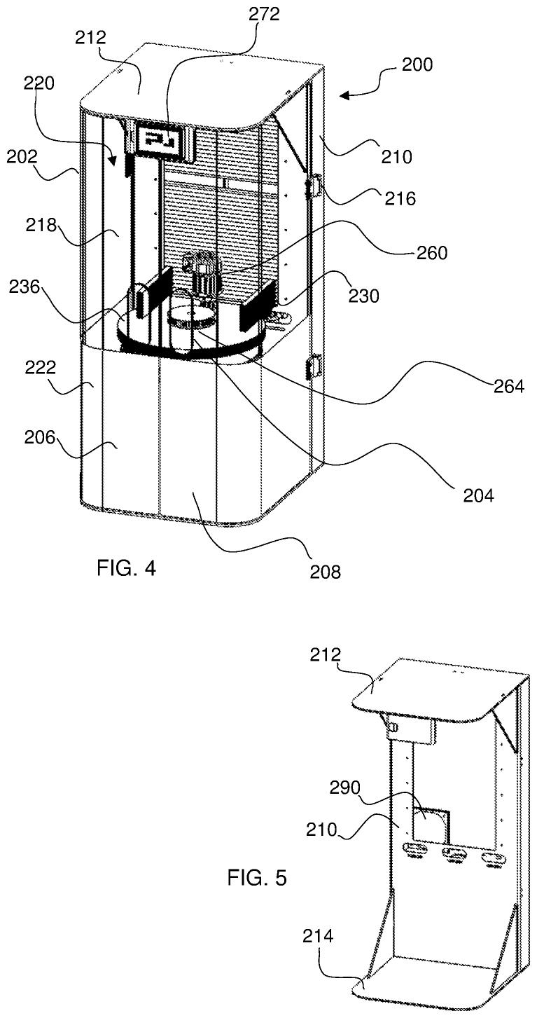

FIG. 4 shows a system 200 according to an embodiment of the present invention. The system 200 provides for removal of resin from 3D objects. The resin removal system 200 includes a housing 202. The housing 202 includes front door panels 206 and 208, a rear frame 210, and a top panel 212. The housing 202 also includes a bottom panel 214 (shown in FIG. 5). The front door panels 206 and 208 are connected to the rear frame 212 by hinges 216 or other means. In one embodiment, the housing 202 is approximately 16.5 inches (419 mm) wide, 36.5 inches (927 mm) high, and 18.7 inches (475 mm) deep.

The front door panels 206 and 208 provide access to an interior of the housing 202. Upper portions 218 of front door panels 206 and 208 include or are formed of a transparent material so that a housing upper portion 220 of the interior of the housing 202 is visible when the front door panels 206 and 208 are closed. Lower portions 222 of the front door panels 206 and 208 are not transparent. The upper portions 218 of the front door panels 206 and 208 may include openings 204 to allow an operator access to the interior of the housing 202 when the door panels 206 and 208 are closed.

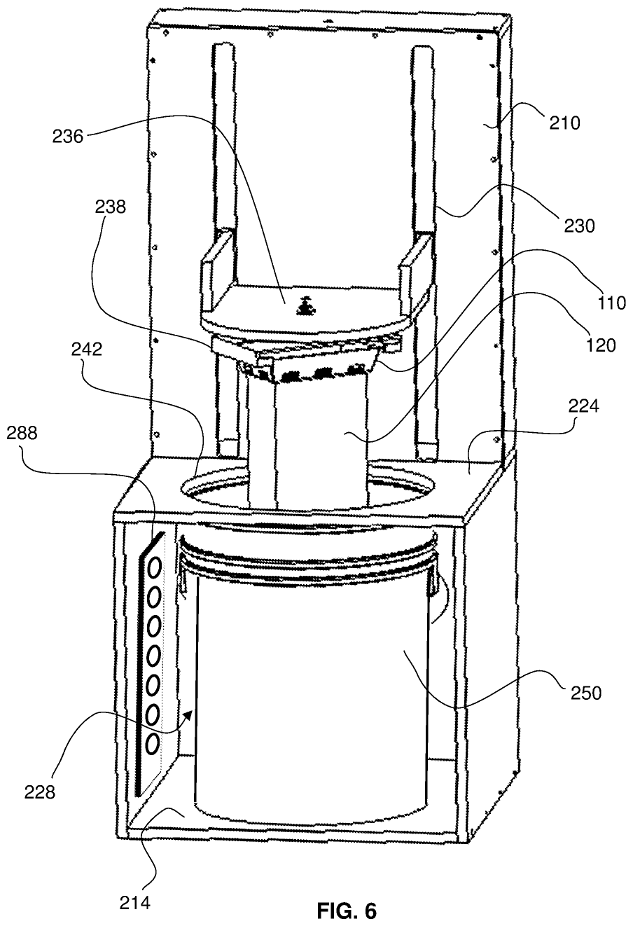

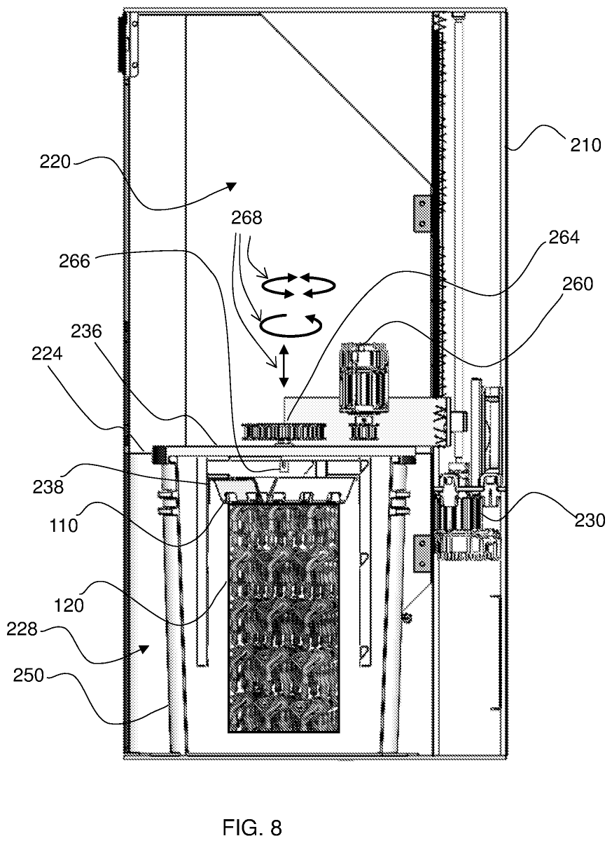

FIG. 6 shows the system 200 with the door panels 206 and 208 removed to show the interior of the housing 202. A horizontal surface 224 extends across the interior of the housing 202. The horizontal surface 224 divides the interior of the housing 202 into the housing interior upper portion 220 (shown in FIGS. 4 and 8) and a housing interior lower portion 228.

A lift mechanism 230 is mounted on the rear frame 210 in the housing interior upper portion 220. Connected to the lift mechanism 230 is a support panel 236. The support panel 236 is adapted to have a build tray mounting fixture 238 attached to a bottom side thereof. The build tray mounting fixture 238 is removably attachable to the bottom side of the support panel 236.

The build tray 110 is attached to the build tray mounting fixture 238. In one embodiment, the build tray 110 is attached to the build tray mounting fixture 238 by magnetic means, such as by having a magnet incorporated into the build tray mounting fixture 238. Other means of attachment may be suitable.

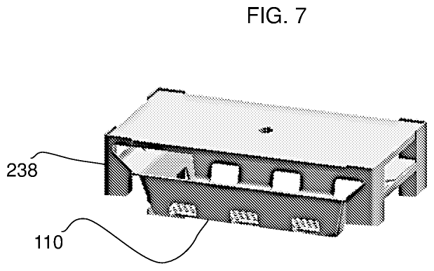

FIG. 7 shows the build tray mounting fixture 238 with the build tray 110 attached thereto on the bottom side thereof. (In FIG. 7, the build tray 110 is shown without any 3D printed objects thereon.) In the embodiment shown in FIG. 7, the build tray mounting fixture 238 attaches to a single build tray 110.

Referring again to FIG. 6, the build tray 110 is attached to the build tray mounting fixture 238 so that the 3D printed objects 120 on the build tray 110 extend downward. The horizontal surface 224 has an opening 242 located therein. The opening 242 is sized to receive the support panel 236, the build tray mounting fixture 238, and the build tray 110 with the 3D printed objects 120 located thereupon.

Located below the horizontal surface 224 in the housing interior lower portion 228 is a detergent container (or vessel or bucket) 250. The detergent container 250 is located directly below the opening 242. The detergent container 250 may have a cylindrical or bucket-like shape. The detergent container 250 may have a capacity of approximately 5 gallons (19 liters). The detergent container 250 may be filled with approximately 4.5 gallons (17 liters) of a detergent. A suitable detergent is PLM-403-SUB available from PostProcess Technologies, Inc. of Buffalo, NY. Suitable detergents are disclosed in WO 2021/195320 and WO 2022/093956, the entire disclosures of which is incorporated by reference herein. In one embodiment, the detergent container 250 also serves as the container in which the detergent is transported or shipped so that the detergent does not need to be transferred from the container in which it was shipped when it is used in the system 200.

The lift mechanism 230 is operable to move the support panel 236 from an upper position to a lower position. When the support panel 236 is in the upper position, it is sufficiently high above the horizontal surface 224 so that the build tray mounting fixture 238 and the entire build tray 110 (including the 3D printed objects 120 located thereupon) can be attached to the bottom side of the support panel 236. When the support panel 236 is in the lower position, the support panel 236 is aligned with the horizontal surface 224. When the support panel 236 is in the lower position, the build tray mounting fixture 238, the build tray 110 and the 3D printed objects 120 located thereupon extend into and are immersed in the detergent in the detergent container 250.

Referring to FIGS. 4 and 8, located on an upper side of the support panel 236 is an agitation motor 260. (The agitation motor 260 is not shown in FIG. 6.) The agitation motor 260 is connected to a gear mechanism 264, which in turn is connected to a shaft 266. The shaft 266 extends through an opening in the center of the support panel 236. The shaft 266 connects to the build tray mounting fixture 238 located beneath the support panel 236. The agitation motor 260 is operable to impart motion to the shaft 266 and in turn to the build tray mounting fixture 238, the build tray 110 and 3D printed objects 120 extending downward therefrom. The agitation motor 260 can impart one or more different kinds of motion (indicated at 268) to the build tray mounting fixture 238, the build tray 110, and 3D printed objects 120. The lift mechanism 230 can also be used to impart motion the build tray mounting fixture 238, the build tray 110, and 3D printed objects 120. These different kinds of motion 268 imparted by the agitation motor 260 or the lift mechanism 230 include a rotational motion about a vertical axis, an oscillating rotational motion about a vertical axis, an up-and-down vertical motion, an oscillating up-and-down vertical motion, a vibratory motion, or any combination of these motions or other motions. In one embodiment, the agitation motor 260 imparts a rotational motion and the lift mechanism 230 imparts a vertical motion. In one embodiment, the agitation motor 260 imparts a rotational motion of approximately 100 rpm to the build tray mounting fixture 238, the build tray 110, and 3D printed objects 120.

A controller (not shown) is connected to the agitation motor 260 and the lift mechanism 230. A user interface 272 (shown in FIG. 4) is also connected to the controller. The controller runs operating software that controls operation of the system 200. The controller is responsive to operating properties of the agitation motor 230, such as load, current, and temperature, among other properties. Embodiments of suitable software are disclosed in US20220032544A1 and US20190270248A1, the entire disclosures of which are incorporated by reference herein. A fan (not show) is located in an opening 290 (shown in FIG. 5) located in the rear frame 210. The fan is operable to provide ventilation to the interior of the housing 202.

Referring again to FIG. 6, in this embodiment, located in the housing interior lower portion 228 on the interior side walls thereof are one or more UV (ultraviolet) light arrays 288. In one embodiment, there are four UV light arrays. The UV light arrays 288 are connected to and operated by the controller. (The UV light arrays 288 are not shown in FIG. 8.)

### Operation

To operate the system 200 for removing resin from a 3D printed objects, the door panels 206 and 208 are opened and the bucket 250 of detergent is installed in the housing interior lower portion 228. In one embodiment, the bucket 250 includes instructions or parameters in a computer-readable code for operating the system 200. The computer-readable code may be a bar code, a QR-code, an RFID, or other code associated with the bucket 250. Alternatively, an operator may use the user interface 272 to specify operating parameters for the system 200. The parameters may include a duration, an agitation level, an agitation type, as well as other parameters. In another alternative, operating instructions or parameters are included in prepared recipes that can be selected by a user or automatically selected using the code associated with the container 250.

With the door panels 206 and 208 open and the support panel 236 in the upper position, the build tray 110 with the 3D printed objects is attached onto the build tray mounting fixture 238. Next, the build tray mounting fixture 238, with the build tray 110 and 3D objects attached thereto, is loaded into the housing upper portion 220 of the system 200. The support panel 236 includes a fastening means to secure the build tray mounting fixture 238 to it. After the build tray mounting fixture 238 is attached to the support panel 236, the door panels 206 and 208 are closed. The lift mechanism 230 is operated to lower the support panel 236 into the lower position. When the support panel 236 is in the lower position, the 3D printed objects on the build tray 110 are immersed in the detergent in the detergent container 250.

Next, the agitation motor 260 and/or the lift mechanism 230 is operated to impart movement to the build tray mounting fixture 238, the build tray 110, and the 3D printed objects 120. As explained above, the motion may be one or more of a rotational motion about a vertical axis, an oscillating rotational motion about a vertical axis, an up-and-down vertical motion, an oscillating up-and-down vertical motion, a vibratory motion, or any combination of these motions or other motions. In some embodiments, more than one different type of motion may be used. In another alternative embodiment, no motion is imparted to the build tray mounting fixture 238 so that the 3D printed objects are allowed to soak in the detergent without any movement. The runtime of the agitation motor 260 and/or the lift mechanism 230 may be determined based on the size, type, or number of 3D printed objects from which resin is being removed. The runtime may be provided in the recipe that was selected. The runtime can vary from several seconds to approximately 30 minutes.

After the specified runtime, the agitation motor 260 and/or the lift mechanism 230 stops imparting motion to the build tray mounting fixture 238. The lift mechanism 230 operates to raise the support panel 236, the build tray mounting fixture 238, the build tray 110 and the 3D printed objects 120 from the lower position to the upper position. At this stage, the unwanted resin has been removed from the 3D printed objects 120. At this point, the system 200 may be used to perform a rinsing step on the 3D printed objects. The rinsing step is optional and may not performed in all cases. Factors that determine whether to perform a rinsing step include the size, type, or number of 3D printed objects from which resin is being removed. To perform the rinsing step, the door panels 206 and 208 are opened, and the container 250 of liquid formulation is removed and replaced with another container that contains a rinsing solution. The rinsing solution may be water, IPA (isopropyl alcohol), or another formulation. In another alternative, the same detergent formulation used for resin removal, or a fresh container of the same formulation used for resin removal, may be used for rinsing. The lift mechanism 230 is operated to lower the support panel 236, the build tray mounting fixture 238, the build tray 110 and the 3D printed objects 120 from the upper position to the lower position. The 3D printed objects 120 are then immersed in the rinsing solution. The agitation motor 250 and/or the lift mechanism 230 may be used to impart motion to the 3D printed objects 120 during the optional rinsing step. The rinsing step is performed for a duration of time, which may be specified in the selected recipe or which may be chosen by an operator. After rinsing is completed, the lift mechanism 230 is operated to raise the support panel 236, the build tray mounting fixture 238, the build tray 110 and the 3D printed objects 120 from the lower position to the upper position.

After the rinsing is completed (or after the resin removal step if no rinsing is performed), the 3D printed objects 120 on the build tray 110 need to be cured. In this embodiment, the curing may be performed in the same housing 202 with the same system 200. Alternatively, the curing may be performed elsewhere in a different apparatus. If the curing is performed in the same housing 202 in the same system 200, the door panels 206 and 208 are opened and the container 250 is removed from the housing interior lower portion 228. Then, the door panels 206 and 208 are closed again. The lift mechanism 230 is operated to lower the support panel 236, the build tray mounting fixture 238, the build tray 110 and the 3D printed objects 120 from the upper position to the lower position. The 3D printed objects 120 are suspended in the housing interior lower portion 228. Then, the one or more UV light arrays 288 are operated to shine UV light on the 3D printed objects 120 to cure them. During the curing stage, the agitation motor 260 is operated to rotate (or oscillate rotationally) the build tray mounting fixture 238, the build tray 110, and the 3D printed objects 120 in order to expose the 3D printed objects to the UV light. The curing stage may continue for approximately a minute to approximately 60 minutes or more, depending on factors, such as the number, geometry, and/or complexity of the 3D printed objects 120. After the curing stage, the UV light array 288 is turned off. The lift mechanism 230 is operated to raise the support panel 236, the build tray mounting fixture 238, the build tray 110 and the 3D printed objects 120 from the lower position to the upper position. At this stage, the 3D printed objects are finished. The door panels 206 and 208 are opened and the build tray mounting fixture 238, the build tray 110 and 3D printed objects 120 are detached from the support panel 236. Then, the build tray 110 and the now clean and cured 3D printed objects 120 are removed from the build tray mounting fixture 238. The system 200 is then ready to be operated to remove unwanted resin from another batch of 3D printed objects on another build tray.

The detergent in the detergent bucket 250 can be reused to remove resin from multiple batches of 3D printed objects. The operating system software in the system 200 keeps track of how many batches of 3D printed objects have been cleaned in order to determine when the bucket of detergent needs to be replaced. A notification may be provided via the user interface 272 or other means about replacing the bucket of detergent. The operating system software may also prevent the system 200 from operating when the detergent is exhausted.

### Alternative Embodiments

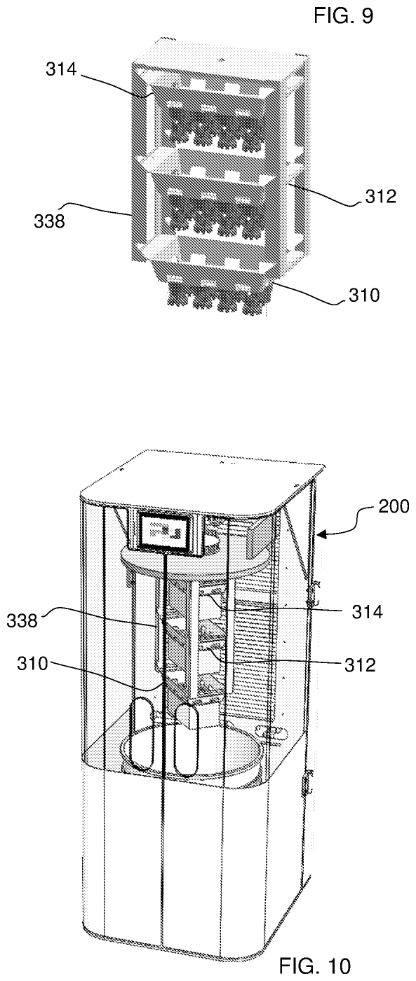

FIG. 9 shows a multi-build tray mounting fixture 338. The multi-build tray mounting fixture 338 is an alternative embodiment of the build tray mounting fixture 238 shown in FIG. 7. The multi-build tray mounting fixture 338 can be used in the system 200 in a manner similar to the way that the build tray mounting fixture 238 is used. The multi-build tray mounting fixture 338 can be mounted below the support panel 236 and connected to the shaft 266 in the same way as the build tray mounting fixture 238. The multi-build tray mounting fixture 338 differs from the build tray mounting fixture 238 in that the multi-build tray mounting fixture 338 can hold multiple build trays. In the embodiment shown in FIG. 8, the multi-build tray mounting fixture 338 can hold up to three build trays 310, 312, and 314. As explained above, a 3D printer, like the printer 100 in FIG. 1, can print objects that extend the entire height of the build envelope 140 (in FIG. 2) or can print objects that occupy only a portion of the height of the build envelope 140, as shown in FIG. 3. When objects are printed that occupy only a portion of the build envelope 140, or a smaller printer having a smaller build envelope 140 is used, there may be room in the system 200 to remove resin from 3D printed objects on more than one build tray at a time. The multi-build tray mounting fixture 338 is used for this purpose. To use the multi-build tray mounting fixture 338, multiple build trays 310, 312, and 314 having 3D printed object are provided. The 3D objects may have been printed using different build trays in the same 3D printer. Alternatively, the 3D objects may have been printed on different build trays in different 3D printers. The multiple build trays 310, 312, and 314 are attached to the multi-build tray mounting fixture 338. Then the multi-build tray mounting fixture 338 is loaded into the housing upper portion 220 of the system 200. The operation of the system 200 using the multi-build tray mounting fixture 338 then proceeds in the same manner as the operation of the system with the single build tray mounting fixture 238.

In this embodiment, the multi-build tray mounting fixture 338 and the build tray mounting fixture 238 are interchangeable. That is, the system 200 can be operated using the single build tray mounting fixture 238 and then after the 3D printed parts on the single build tray mounting fixture 238 are cleaned, the multi-build tray mounting fixture 338 can be used in the same system 200 to clean 3D objects on multiple build trays.

The multi-build tray mounting fixture 338 can be used with a single build tray 110 that has 3D printed objects on it that occupy the entire build envelope 140 of the build tray 110.

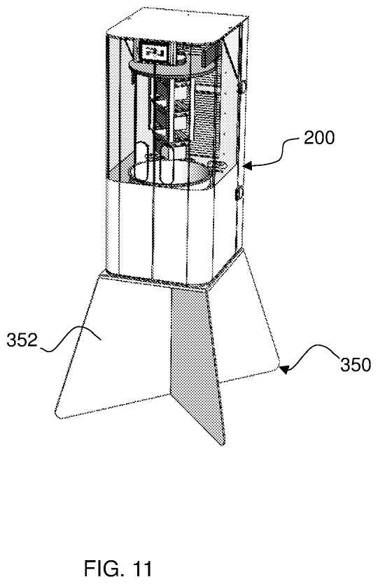

FIG. 11 shows an accessory that can be used with an embodiment of the system 200. FIG. 11 shows a pedestal 350. The system 200 in FIG. 11 is mounted atop of the pedestal 350. The pedestal 350 has a vertical dimension of approximately 12 inches (30 cm). Therefore, the pedestal 350 elevates the system 200 by approximately this height. The pedestal 350 is formed of four panels or fins 352. The pedestal 350 can be used with the system 200 for desktop applications or to facilitate access to the system 200 for loading and unloading build trays.

In further alternative embodiments, system for removal of resin from 3D objects can be implemented as or incorporated into cyber-physical systems. For example, sensors associated with the system can automatically detect properties of built objects on a build tray and select appropriate operating parameters. Sensors may also be used to detect when the resin has been removed or when curing has been completed. Similarly, a user interface of a system for removal of resin from 3D objects can automatically identify an operator who loaded the build tray into the system, and then automatically inform the operator when the resin removal process or curing process is complete, e.g., by sending a message to the operator's phone. Various other features can be provided when the system for removal of resin from 3D objects implemented as a cyber-physical system.

In another further alternative embodiment, the system may include a mechanism, such as a turntable, for imparting movement, e.g., rotation, oscillation, vibration, to the container of detergent instead of, or in addition to, the mechanism that imparts movement to the build tray.

In another alternative, a baffle may be used to enhance the flow of detergent into and around the build tray. The baffle may be an optional feature. The baffle may be formed of one or more fins or channels located between the inside walls of the container and the build tray. In one embodiment, the baffle is affixed against and extends inward from the inside walls of the container. In another embodiment, the baffle may extend downward from the support platform 236. The baffle may be removable so that it can used when desired. The baffle may be used to enhance the flow around the build tray depending on the size, geometry, or composition of the parts in the build tray, as well as other factors. The baffle may be composed of plastic or other durable material.

In still another alternative, the flow of detergent around the build tray in the container may be enhanced by an impeller. The impeller may be an optional feature. The impeller may be located between the inside walls of the container and the build tray. In one embodiment, the impeller may extend downward from the support platform 236. The impeller may be connected by a gear mechanism to a motor located above the support platform 236. The impeller may be removable so that it can used when desired. The impeller may be used in conjunction with the baffle or may be used separately.

In other alternative embodiments, the system does not include UV lights or has UV light arrays that are removable. According to these alternatives, curing may be performed at a location other than in the resin removal system housing. It may be efficient in some cases to perform curing at a location other than in the resin removal system in order to make the resin removal system available to remove resin from additional batches while curing of batches from which resin has already been removed takes place elsewhere at the same time.

In the foregoing description, example embodiments are described. The specification and drawings are accordingly to be regarded in an illustrative rather than a restrictive sense.

It will be appreciated that various aspects of the above-disclosed invention and other features and functions, or alternatives thereof, may be desirably combined into many other different systems or applications. Various presently unforeseen or unanticipated alternatives, modifications, variations, and/or improvements therein may be subsequently made by those skilled in the art, and those alternatives, modifications, variations, and/or improvements are intended to be encompassed by the following claims.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1-27. (canceled)

28. A system for removing resin from 3D printed objects, comprising:
a housing;
a fixture located in the housing and adapted for attaching thereto on a bottom side thereof a build tray, wherein the build tray is a component of a 3D printer upon which the 3D printed objects are manufactured, wherein the build tray is removable from the 3D printer with built 3D printed objects located thereupon; and
a lift mechanism located in the housing and connected to the fixture, wherein said lift mechanism is adapted for moving the fixture from an upper position to a lower position;
wherein when the lift mechanism is in the lower position, the built 3D printed objects located on the build tray attached to the lift mechanism are immersed into a liquid formulation contained in a container positioned below the lift mechanism to thereby remove resin from the built 3D printed objects.

29. The system of claim 28 further comprising:
an agitation mechanism located in the housing, said agitation mechanism adapted to impart motion to the build tray when the build tray is in the liquid formulation.

29. The system of claim 29 wherein the agitation mechanism is adapted to at least one of:
rotate the build tray about a vertical axis in the liquid formulation,
oscillate the build tray rotationally about a vertical axis in the liquid formulation, and
oscillate the build tray vertically in the liquid formulation.

31. The system of claim 28 wherein the container comprises a 5 gallon (19 liter) bucket.

32. The system of claim 28 wherein the container is a same container in which the liquid formulation was transported.

33. The system of claim 28 wherein said fixture is adapted for attaching thereto up to 3 build trays.

34. The system of claim 28 wherein said fixture is adapted for attaching thereto the build tray magnetically.

35. The system of claim 28 further comprising:
a pedestal upon which the housing is located.

36. The system of claim 28 further comprising:
a UV light array located in the housing wherein when the lift mechanism is in the lower position, the built 3D printed objects located on the build tray attached to the lift mechanism are exposed to UV light from the UV light array to thereby cure the built 3D printed objects.

37. The system of claim 28 further comprising:
a baffle located between an inside wall of the container and the build tray when the build tray is immersed in the liquid formulation.

38. The system of claim 28 further comprising:
an impeller located in the liquid formulation in the container when the build tray is immersed in the liquid formulation.

39. A method for removing resin from 3D printed objects, comprising:
placing a container that contains a liquid formulation in a housing of a resin removal system;
attaching a build tray that had been removed from a 3D printer to a fixture of said system, wherein said build tray has 3D printed objects located thereupon;
lowering the fixture with the build tray attached thereto so that the build tray is immersed in said liquid formulation in the container; and
removing the resin from the 3D printed objects with the liquid formulation.

40. The method of claim 39 further comprising:
agitating the build tray when the build tray is in the container.

41. The method of claim 40 wherein the agitating comprises rotating the build tray about a vertical axis in the liquid formulation.

42. The method of claim 40 wherein the agitating comprises oscillating the build tray about a vertical axis in the liquid formulation.

43. The method of claim 40 wherein the agitating comprises oscillating the build tray vertically in the liquid formulation.

44. The method of claim 39 further comprising:
sensing a code associated with the container; and
operating the system to remove the resin in response to the code.

45. The method of claim 39 further comprising:
after removing the resin from the 3D printed objects with the liquid formulation, removing the container that contains the liquid formulation used for removing the resin;
lowering the fixture with the build tray attached thereto; and
exposing the 3D printed objects to UV light emitted from a UV light array to thereby cure the 3D printed objects.

39. The method of claim 39 further comprising:
after removing the resin from the 3D printed objects with the liquid formulation, replacing the container that contains the liquid formulation used for removing the resin;
replacing the container that contains the liquid formulation used for removing the resin with another container that contain a rinse solution;
lowering the fixture with the build tray attached thereto so that the build tray is immersed in said rinse solution;
rinsing the 3D printed objects with the rinse solution;
raising the fixture with the build tray attached thereto so that the build tray is removed from said rinse solution;
removing the container that contains said rinse solution;
lowering the fixture with the build tray attached thereto; and
exposing the 3D printed objects to UV light emitted from a UV light array to thereby cure the 3D printed objects.

47. A method for removing resin from 3D printed objects, comprising:
placing a container that contains a liquid formulation in a housing of a resin removal system;
attaching a build tray that had been removed from a 3D printer to a fixture of said system, wherein said build tray has 3D printed objects located thereupon;
lowering the fixture with the build tray attached thereto so that the build tray is immersed in said liquid formulation in the container;
removing the resin from the 3D printed objects with the liquid formulation;
after removing the resin from the 3D printed objects with the liquid formulation, replacing the container that contains the liquid formulation used for removing the resin;
replacing the container that contains the liquid formulation used for removing the resin with another container that contain a rinse solution;
lowering the fixture with the build tray attached thereto so that the build tray is immersed in said rinse solution; and
rinsing the 3D printed objects with the rinse solution.
